(19) United States
(12) Patent Application Publication
(10) Pub. No.: US 2008/0115951 A1
(43) Pub. Date: May 22, 2008

(54) GROUND-WORKING TOOL AND REPLACEMENT BLADES FOR USE THEREWITH

(76) Inventors: Louis Zuccarello, Whitestone, NY (US); Franco Romito, Whitestone, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/938,560

(22) Filed: Nov. 12, 2007

Related U.S. Application Data
(63) Continuation-in-part of application No. 11/598,530, filed on Nov. 13, 2006.
(60) Provisional application No. 60/834,642, filed on Aug. 1, 2006.
(60) Provisional application No. 60/858,840, filed on Nov. 14, 2006.

(51) Int. Cl. A01B 1/12; A01B 41/02; A01B 33/04

(52) U.S. Cl. 172/42; 172/54.5

(57) ABSTRACT

A ground-working tool is including a shaft, a drive motor, a gear set, at least one arm and at least one head is disclosed. The drive motor is disposed in mechanical cooperation with the shaft. The gear set is configured to be driven by the drive motor. The arm is disposed in mechanical cooperation with the gear set and defines a longitudinal axis. The head is disposed in mechanical cooperation with the arm. The arm is movable proximally and distally in a reciprocating motion. At least one blade is selectively removable from the head.

### CROSS REFERENCE TO RELATED APPLICATIONS

This application is a Continuation-In-Part of U.S. patent application Ser. No. 11/598,530 (Attorney Docket No. 1588-2) entitled “Ground-Working Tool,” which was filed on Nov. 13, 2006, which claims the benefits of and priority to U.S. Provisional Patent Application Ser. No. 60/834,642 entitled “SOIL CULTIVATOR” which was filed on Aug. 1, 2006. The present application also claims the benefits of and priority to U.S. Provisional Patent Application Ser. No. 60/858,840 entitled “Replacement Blades for Ground-Working Tool,” which was filed on Nov. 14, 2006. The entire contents of each of these applications are hereby incorporated by reference herein.

### BACKGROUND

1. Field of the Disclosure

The present disclosure relates to a ground-working tool. More particularly, the present disclosure relates to a hand-held tool for cultivating soil.

2. Background of the Art

Cultivation of an area of soil, e.g., a garden plot, is a time-consuming but important task to ensure plants having good yield and a healthy-looking yard or garden. Typically, a gardener will use an tool, such as a hoe, to loosen and turn the soil between adjacent rows of plants and/or to remove any undesired growths, such as weeds. In addition to destroying weeds, soil that has become hard and packed down e.g., from watering, is loosened. This allows air to penetrate the soil and also facilitates watering the plants. Since this type of cultivation can be extremely time consuming and requires substantial physical labor, several power-driven tools have been developed for cultivation.

Many power-driven tools have blades or tool heads that rotate 360°. Such a complete rotation often creates various hazards, including projecting stones, pebbles, plastic, etc., which can injure a worker, bystander or nearby property. Additionally, weeds and grass are known to become tangled in cultivation devices that rotate 360°. Accordingly, a ground-working tool have at least one reciprocating blade would be a welcome addition to the art.

### SUMMARY

The present disclosure relates to a ground-working tool including a shaft, a drive motor, a gear set, at least one arm and at least one head is disclosed. The drive motor is disposed in mechanical cooperation with the shaft. The gear set is configured to be driven by the drive motor. The arm is disposed in mechanical cooperation with the gear set and defines a longitudinal axis. The head is disposed in mechanical cooperation with the arm. The arm is movable (e.g., confined to move) proximally and distally in a reciprocating motion. At least one blade is selectively removable from the head.

In an embodiment, the at least one arm includes a first arm defining a first longitudinal axis and a second arm defining a second longitudinal axis. Activation of the drive motor causes the first arm and the second arm to reciprocatingly move in opposite directions from one another. In an embodiment, the first longitudinal axis and the second longitudinal axis are substantially to one another. In another embodiment, the first and second longitudinal axes are disposed at an angle θ to each other—the angle θ being between about 5′ and about 35°.

In a disclosed embodiment the head includes a plurality of tines. In another embodiment, the head includes a blade having an elongated cutting surface where the elongated cutting surface is disposed substantially parallel to the longitudinal axis.

In an embodiment, the head is removably secured to the arm. Additionally, it is disclosed that at least a portion of the tool is configured to be hand-held.

The present disclosure also relates to a ground-working attachment that is removeably securable to a hand held motorized shaft. The attachment includes, a housing, a gear set, at least one arm and at least one head. The gear set is disposed at least partially within the housing. The arm is disposed in mechanical cooperation with the gear set and defines a longitudinal axis. The head is disposed in mechanical cooperation with the arm. The arm is movable proximally and distally in a reciprocating motion.

The present disclosure also relates to a method of cultivating soil. The method includes the steps of providing a tool (such as a ground-working tool described above), activating the drive motor to cause the arm to reciprocate and placing at least a portion of the tool adjacent soil.

### BRIEF DESCRIPTION OF THE DRAWINGS

Embodiments of the present disclosure are described hereinbelow with reference to the drawings wherein:

FIG. 1 is a perspective view of a ground-working tool according to an embodiment of the present disclosure;

FIG. 1A is an enlarged perspective view of the ground-working tool according to FIG. 1;

FIGS. 2 and 3 are top views of a working end of the ground-working tool of FIG. 1, in accordance with an embodiment of the present disclosure;

FIGS. 4-6 are top views of a pair of heads of the ground-working tool of FIGS. 1-3, in accordance with an embodiment of the present disclosure;

FIG. 7 is a side view of an embodiment of the working end of the ground-working tool of FIGS. 1-6;

FIG. 8 is a perspective view of an embodiment of the working end of the ground-working tool of FIGS. 1-7;

FIG. 9 is an assembly view of the working end of the ground-working tool of FIGS. 1-8; in accordance with an embodiment of the present disclosure;

FIGS. 10-13 are top views of a gear set of the ground-working tool of FIGS. 1-9, in accordance with an embodiment of the present disclosure;

FIG. 14 is an assembly view of a portion of the ground-working tool of FIG. 8 showing a replacement blade in accordance with an embodiment of the present disclosure;

FIG. 14A illustrates four replacement blades of FIG. 14 in a package;

FIG. 15 is an assembly view of a portion of the ground-working tool of FIG. 9 showing a replacement blade in accordance with an embodiment of the present disclosure; and

FIG. 15A illustrates four replacement blades of FIG. 15 in a package.

### DETAILED DESCRIPTION

Embodiments of the presently disclosed ground-working tool are now described in detail with reference to the drawings, in which like reference numerals designate identical or corresponding elements in each of the several views. As used herein the term “distal” refers to that portion of the ground-working tool, or component thereof, farther from the user while the term “proximal” refers to that portion of the ground-working tool or component thereof, closer to the user.

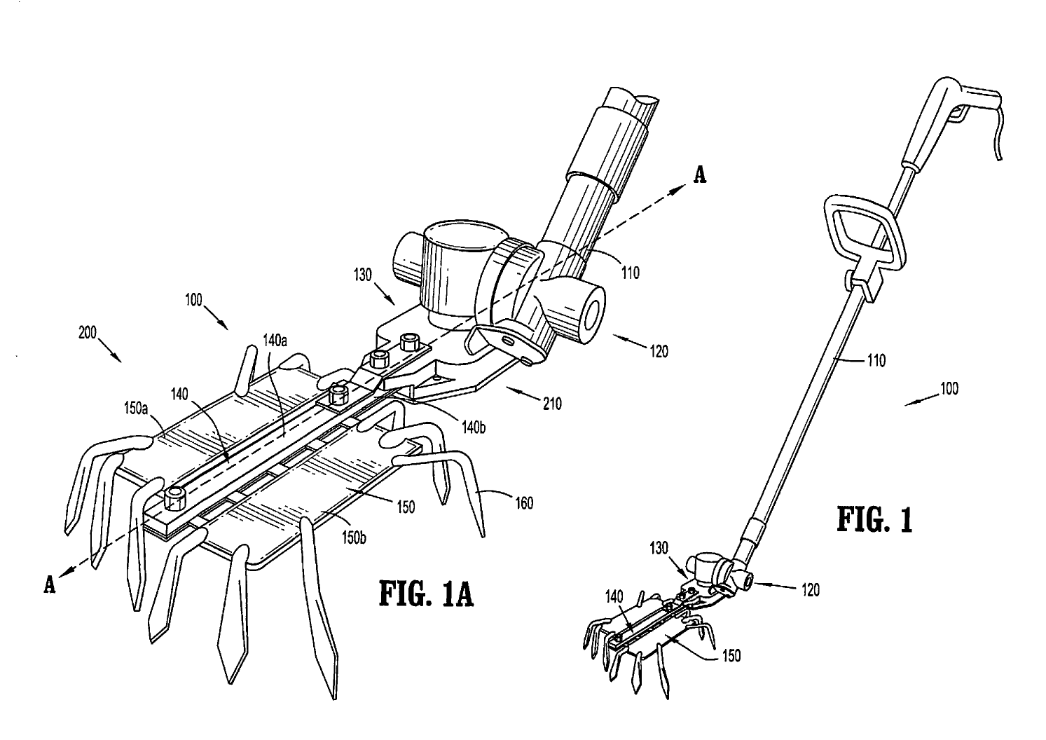

A ground-working tool, e.g., a soil cultivator, in accordance with the present disclosure is referred to in the figures as reference numeral 100. Referring initially to FIGS. 1 and 1A, ground-working tool 100 includes a shaft 110, a drive motor 120, a gear set 130, at least one arm 140 and at least one head 150. Drive motor 120 is disposed in mechanical cooperation with shaft 110 and gear set 130 is configured to be driven by drive motor 120. Any conventional methods, such as electric, battery or gas, for example, may be used to power drive motor 120. At least one arm 140 (two arms 140a and 140b are illustrated in FIG. 1A) is disposed in mechanical cooperation with gear set 130 and defines longitudinal axis A-A. At least one head 150 (two heads 150a and 150b are illustrated in FIG. 1A) is disposed in mechanical cooperation with at least one arm 140. Ground-working tool 100 of the present disclosure is illustrated as a hand-held tool, but it is envisioned that ground-working tool 100 is a functional tool without being of a hand-held variety.

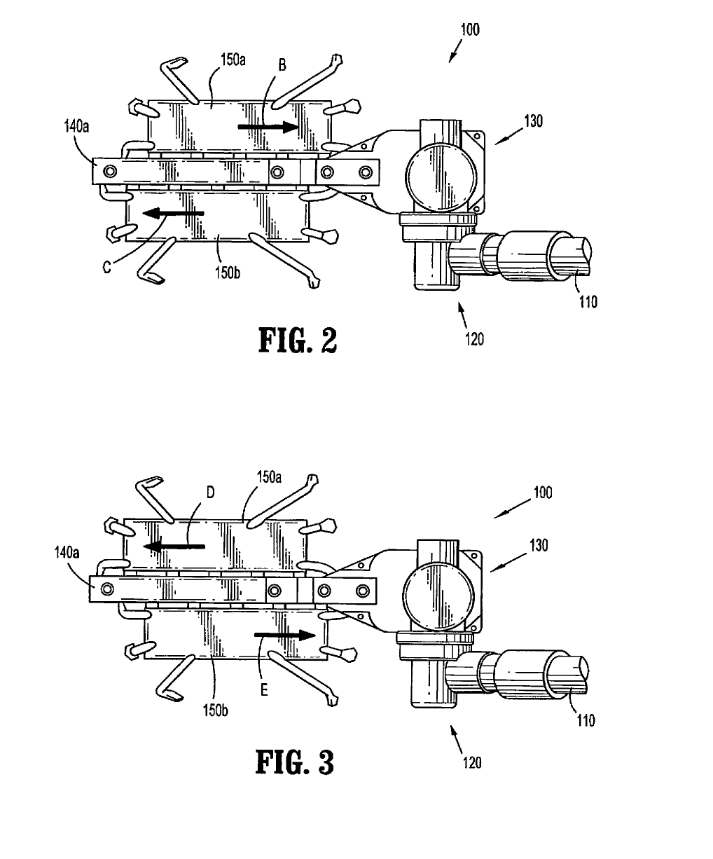

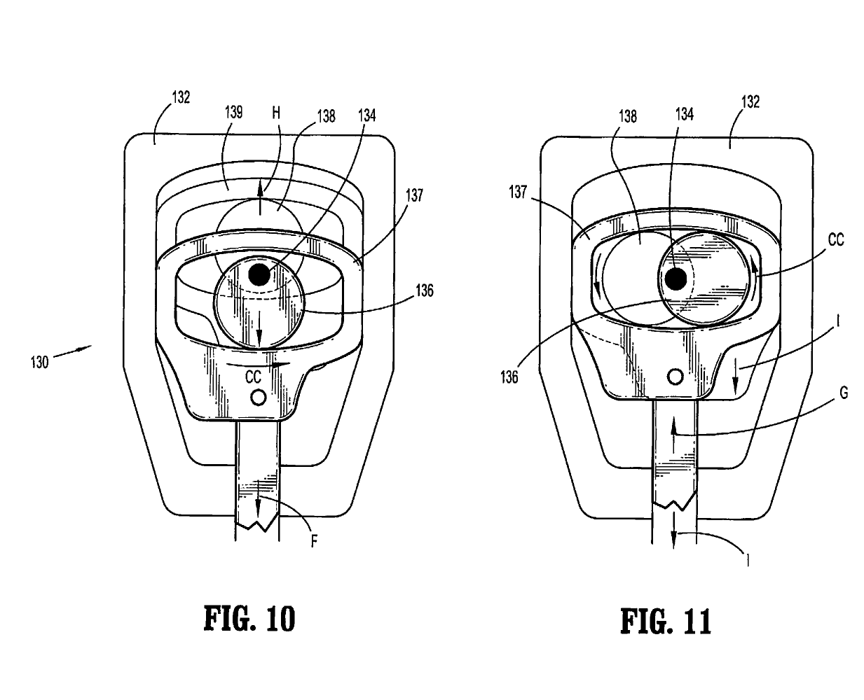

Referring now to FIGS. 2 and 3, ground-working tool 100 is configured to provide reciprocating motion to arm 140. Each arm 140a, 140b (arm 140b is hidden from view in FIGS. 2 and 3) is in mechanical cooperation with a portion of gear set 130, which produces the desired motion (as discussed in detail below with reference to FIGS. 10-13). In the illustrated examples, two arms 140a and 140b reciprocatingly move proximally and distally, in opposite directions from each other. As further illustrated, heads 150a and 150b are disposed in mechanical cooperation with each arm 140a and 140b, respectively. More specifically, with reference to FIG. 2, as arm 140a (and head 150a) moves proximally in the direction of arrow B, arm 140b (and head 150b) moves distally in the direction of arrow C. With reference to FIG. 3, after arms 140a and 140b have reached their respective proximal and distal limits, arm 140a (and head 150a) moves distally in the direction of arrow D and arm 140b (and head 150b) moves proximally in the direction of arrow E.

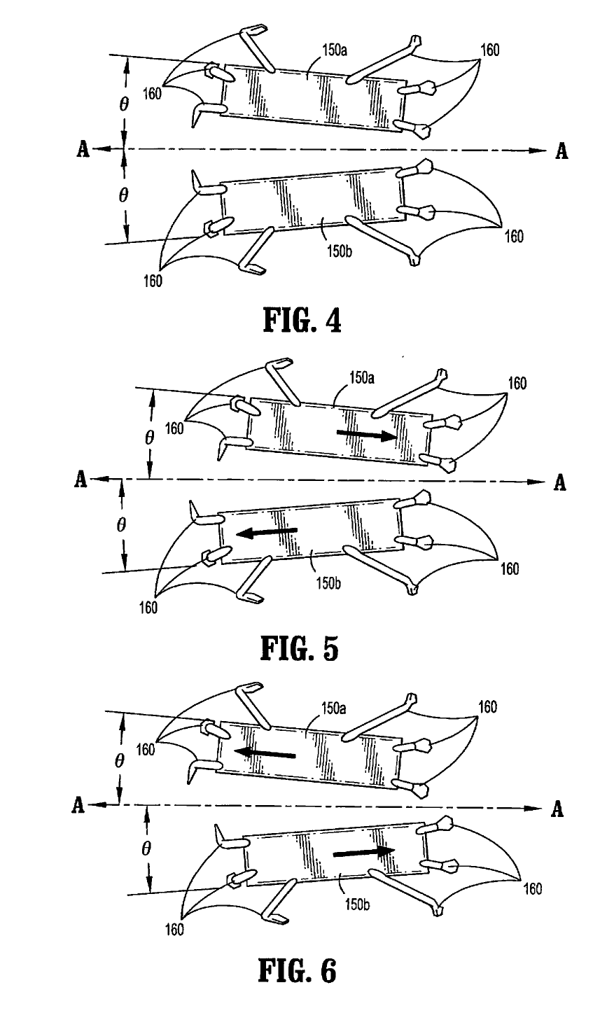

With reference to FIGS. 4-6, arms 140a, 140b and heads 150a, 150b are illustrated disposed at an angle θ (FIG. 4) from longitudinal axis A-A. Here, arm 140a defines axis B-B and arm 140b defines axis C-C. Disposing arms 140a and 140b at an angle with respect to longitudinal axis A-A may be desirable for various reasons, including increasing the total soil-contacting area. The angle θ may be any reasonable angle, including all angles between about 5° and about 35° (in addition to being about θ°, substantially parallel). To accommodate proximal and distal movement of arms 140a and 140b at an angle θ with respect to longitudinal axis A-A, it is envisioned that arms 140a and/or 140b are bent into an corresponding angle, as shown in FIG. 4. It is also envisioned that portions of gear set 130 are angled to facilitate angular reciprocated motion of arms 140a, 140b. Although not explicitly shown, it is envisioned that arms 140a and 140b are adjustable to provide a variety of angles θ.

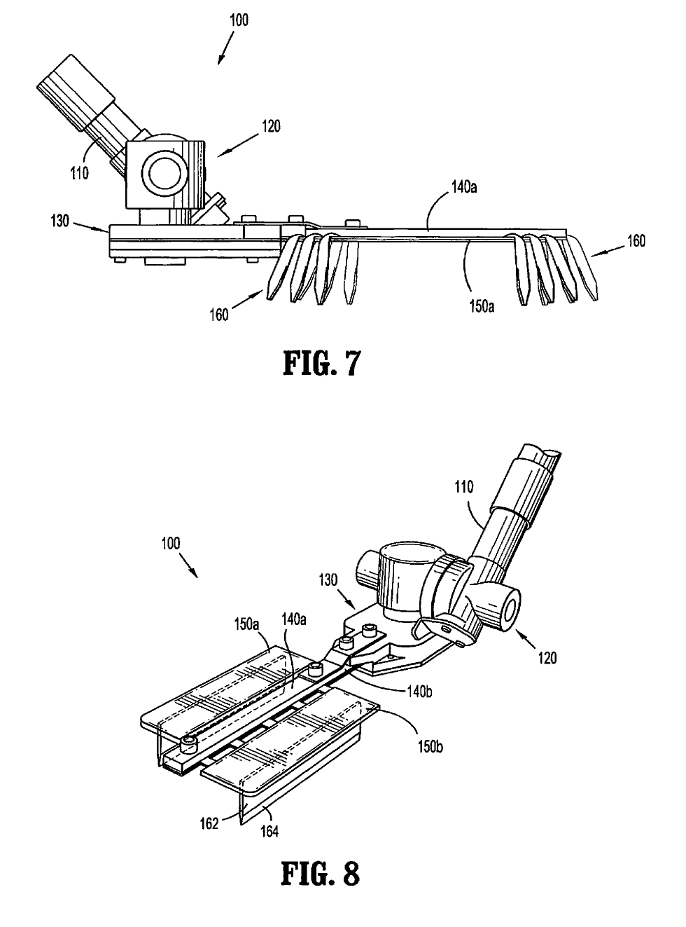

Referring now to FIGS. 1-7 and 9, heads 150a and 150b are each illustrated including a plurality of tines 160. While the same number (i.e., six) of tines 160 is illustrated in each of FIGS. 1-7 and 9, it is envisioned and within the scope of the present disclosure that more or fewer tines 160 are included on each head 150a, 150b. Additionally, each head 150a and 150b may have different number of tines 160 from each other. The arrangement of tines 160 is also similarly illustrated in FIGS. 1-7 and 9 (i.e., each tine 160 is shown in approximately the same location on head 150), however other arrangements are anticipated and within the scope of the present disclosure, including each head 150a and 150b having a different tine 160 arrangement from one another.

With reference to FIG. 8, each head 150a, 150b of ground-working tool 100 includes a blade 162 having an elongated ground-contacting surface 164. As used herein, the terms blade and tine are defined to include extensions that may or may not include a sharp portion. Such an embodiment may be desired in certain situations for a particular gardening use. It is also envisioned to include blade 162 in embodiments where arms 140a, 140b are disposed at an angle θ with respect to longitudinal axis A-A. As can be appreciated, the inclusion of blades 162 (especially blades 162 that are substantially parallel to longitudinal axis A-A) in ground-working tools where the blades rotate 360° would not work very well (if at all). The present disclosure also contemplates heads 150 that are removably securable to arms 140. For instance, grooves (not explicitly shown) or other suitable structure in head 150 may accept arm extensions 141 (shown in FIG. 8) or other suitable structure to enable head 150 to be removably secured to arm 140.

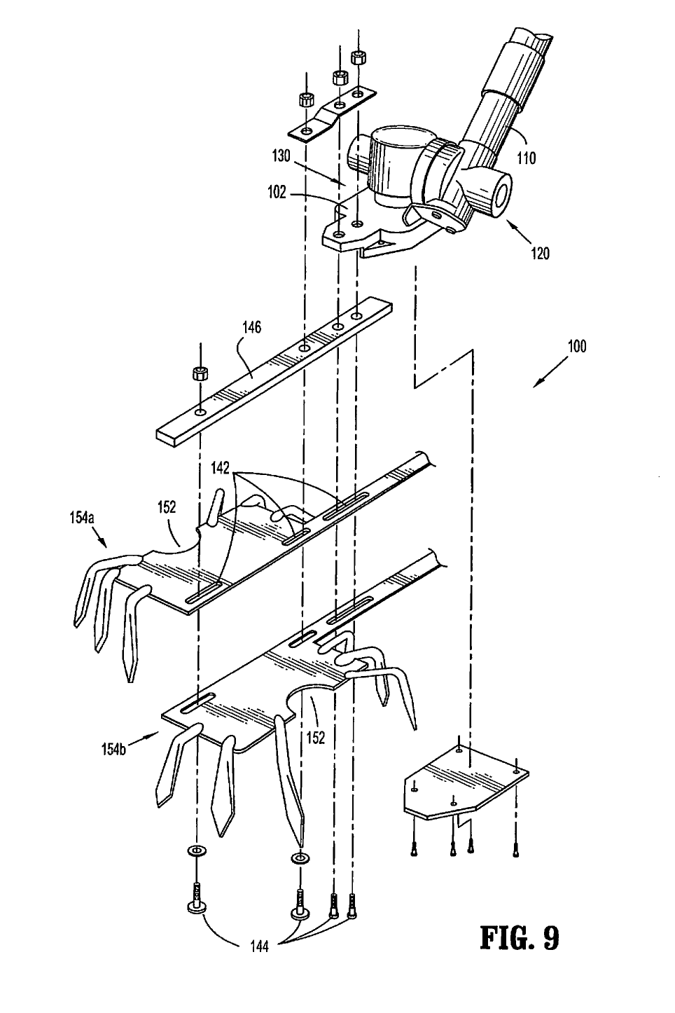

Now referring to FIG. 9, an assembly drawing of portions of ground-working tool 100 is illustrated in accordance with an embodiment of the present disclosure. As is shown, arms 140a and 140b are slidable with respect to each other. This slidable interaction between arms 140a and 140b is facilitated by a series of slots 142a, 142b disposed in each arm 140a, 140b and a plurality of pins 144 (e.g., screws), each of which extend through a slot 142 of each arm 140. A fixed arm 146 is also shown in this embodiment, which is fixedly secured to a housing 102 of ground-working tool 100. Here, arms 140a and 140b are also slidable with respect to fixed arm 146. Additionally, arms 140a and 140b are confined to proximal and distal movement relative to gear set 130 (disposed at least partially within housing 102 and hidden in this figure).

With continued reference to FIG. 9, heads 150a and 150b include a cut-out 152 therein, which reduces the amount of material necessary for manufacturing, and thus reduces the weight of ground-working tool 100. Additionally, a first arm/head set 154a (including arm 140a and head 150a) and a second arm/head set 154b (including arm 140b and head 150b) are each illustrated as being formed by a single piece of material, in accordance with an embodiment of the present disclosure. The material used to construct arms 140a, 140b, heads 150a, 150b or am/head sets 154a, 154b may include, for example, metal, steel, semi-steel, plastic (e.g., hardened plastic), etc., or any combinations thereof.

FIGS. 10-13 illustrate an example of gear set 130 and how the reciprocated motion is produced. In this embodiment, gear set 130 includes a gear housing 132, a pivot 134, a first gear 136, a first gear box 137, a second gear 138 and a second gear box 139. In this embodiment, pivot 134 is rotated via drive motor 120 (e.g., via bevel gears, not shown). Pivot 134 is in mechanical cooperation with first gear 136 and second gear 138, such that upon rotation of pivot 134, first gear 136 and second gear 138 rotate accordingly. Therefore, as pivot 134 rotates counter-clockwise in the direction of arrows CC in FIGS. 10-13, for example, first gear 136 and second gear 138 also rotate counter-clockwise. Further, first gear box 137 and second gear box 139 are slidably mounted within gear housing 132.

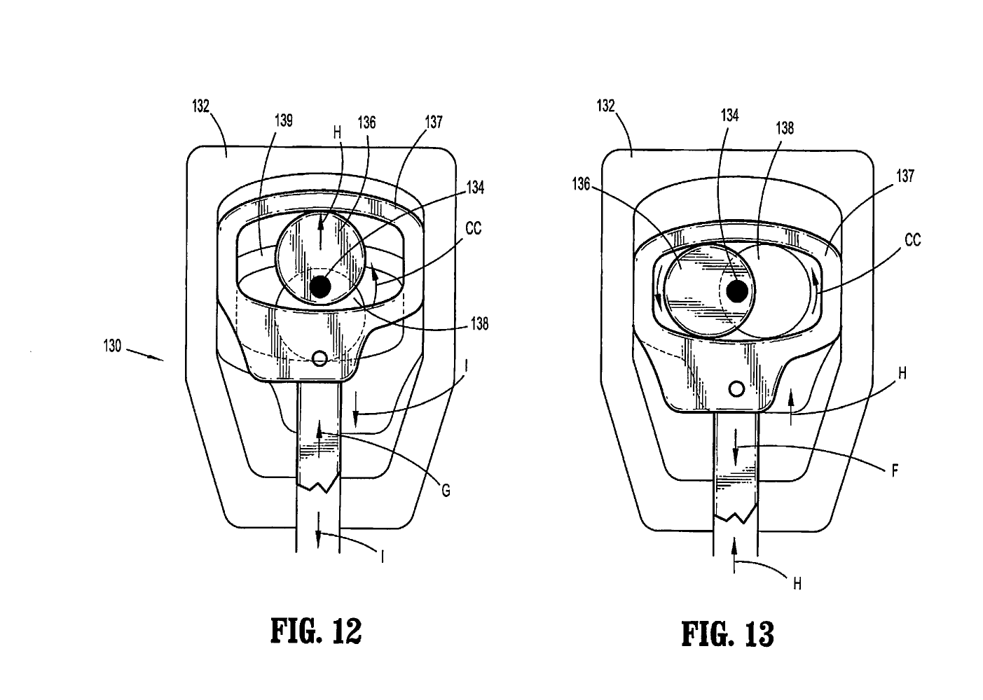

As can be seen with reference to FIGS. 10-13, rotation of first gear 136 and second gear 138 causes first gear box 137 and second gear box 139, respectively, to travel distally and proximally within gear housing 132. More specifically, FIGS. 10-13 illustrate a complete rotation of first gear 136 and second gear 138 and the corresponding motion of arms 140a and 140b, mechanically secured to first gear box 137 and second gear box 139, respectively. When first gear 136 is rotated distally relative to pivot 134, first gear box 137 and first arm 140a are translated distally in the direction of arrow F in FIG. 10. Upon continued rotation of pivot 134, the corresponding rotation of first gear 136 causes first gear box 137 and first arm 140a to move proximally in the direction of arrow G (FIG. 11). The continued rotation of pivot 134 and first gear 136 are illustrated in FIGS. 12 and 13. Second gear 138 is shown disposed about 180° opposite of first gear 136. Thus, as pivot 134 rotates, second gear 138, second gear box 139 and second arm 140b move in opposite directions as first arm 140a (i.e., second arm 140b moves proximally in the direction of arrow H in FIG. 10 and distally in the direction of arrow I in FIG. 11). It is also envisioned and within the scope of the present disclosure that other types of gears and combination of gears may be used to produce reciprocated motion.

The present disclosure also relates to a ground-working attachment 200 (see FIG. 1, for example) that is removably securable to shaft 110. Attachment 200 includes a housing 210, gear set 130, at least one arm 140 and at least one head 150. Gear set 130 is disposed at least partially within housing 210. Arm 140 is disposed in mechanical cooperation with gear set 130 and arm 140 is movable proximally and distally in a reciprocating motion, as described above with reference to ground-working tool 100. Head 150 is disposed in mechanical cooperation with arm 140.

The present disclosure also relates to a method of cultivating soil. The method includes the steps of providing a tool, such as ground-working tool 100 described above, activating drive motor 120 and placing at least a portion of the tool adjacent soil.

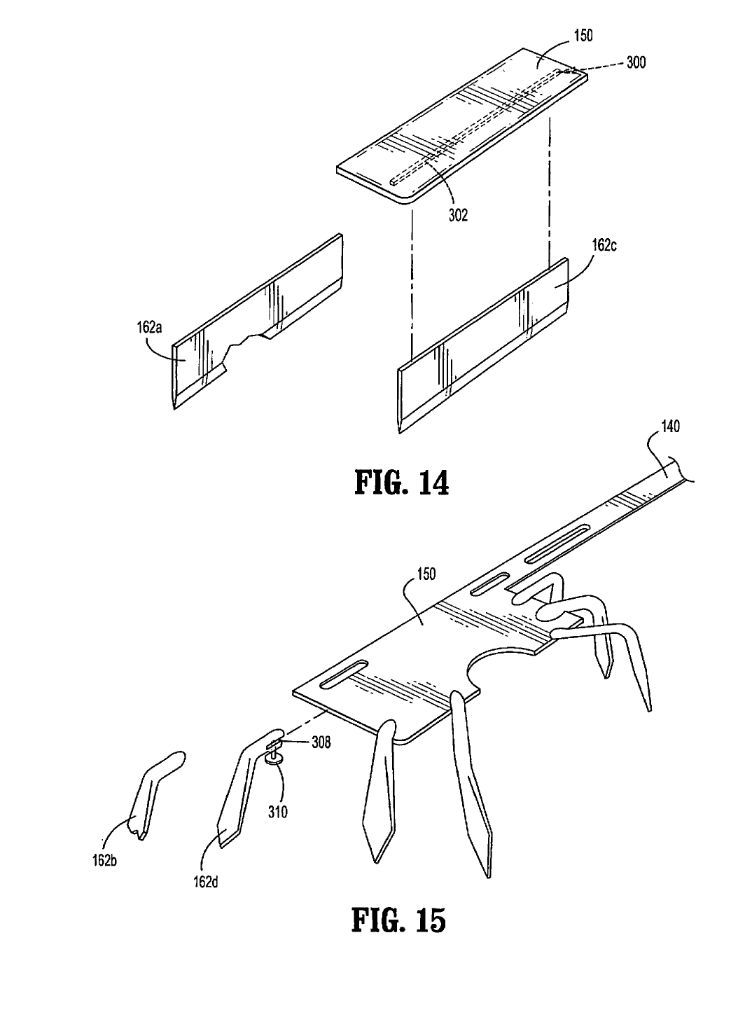

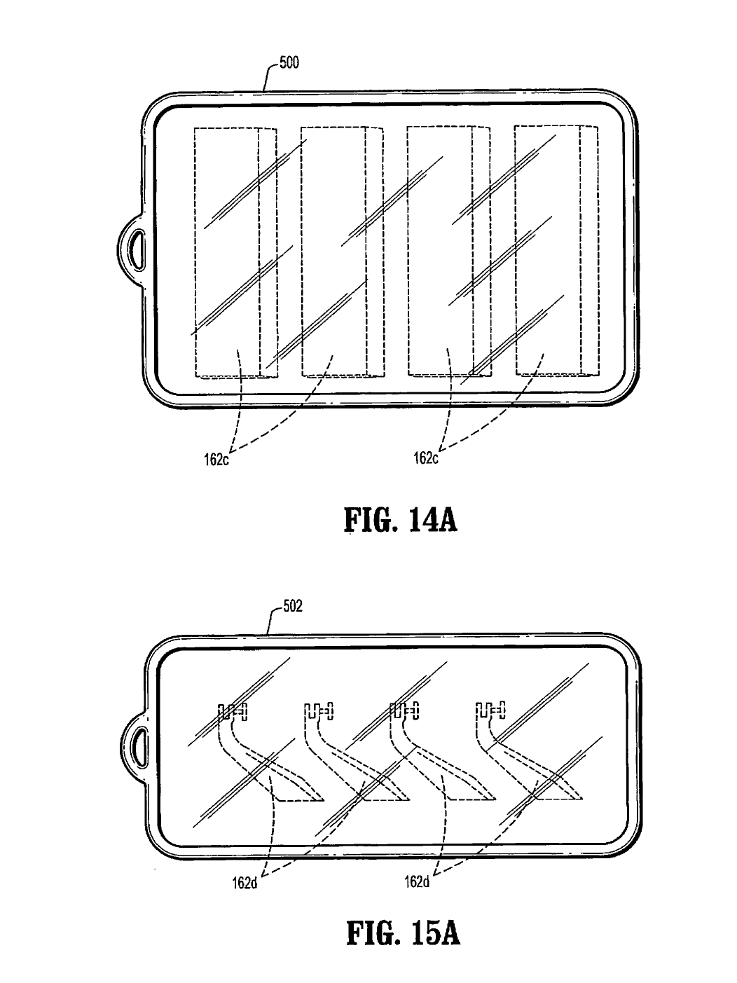

Now referring to FIGS. 14-15A, the present disclosure also includes a ground-working tool 100 (or an attachment for use therewith) that includes replaceable tines or blades (collectively referred to as reference numeral 162 in this embodiment). The present disclosure also relates to replacement tines or blades 162 for use with a ground-working tool 100. During use of a ground-working tool 100, it is envisioned that the tines and/or blades 162 may be subject to a high amount of stress and wear and tear, for example, when used in relatively hard soil. As a result, the tines/blades 162 may at least partially break or become worn beyond efficient use (see worn blade 162a in FIG. 14 and worn blade 162b). If and when a user wants to replace worn blade 162a, 162b, user may remove the worn blade 162a, 162b and replace it with a new blade 162c (FIG. 14), 162d (FIG. 15).

According to an embodiment of the present disclosure, a portion of the ground-working tool 100 (e.g., the arm, shaft or head, for example) includes structure 300 (e.g., pre-cut slots, grooves, tabs, openings, etc.) that enables removable connection of a tine or blade 162. For example, a blade or tine 162 is able to be removably snapped or slid onto the arm 140 or head 150 of a ground-working tool 100. Other ways of removably securing a tine or blade 162 to a portion of a ground-working tool 100 is also envisioned by the present disclosure.

With specific referent to the embodiment illustrated in FIG. 14, worn blade 162a may be removed (e.g., slid, pulled) from a slot 302 and new blade 162c may be inserted (e.g., slid, pushed) into slot 302. With specific reference to the embodiment illustrated in FIG. 15, worn blade 162b may be removed (e.g., pried off, pulled off, unscrewed off) from a portion of head 150. It is envisioned that head 150 includes structure thereon to facilitate attachment of a replacement blade 162 thereto. For instance, head 150 may include a notch or hole disposed at least partially therethrough to accept a portion of a screw 310, for instance. It is also envisioned that blade 162 includes structure 308 (e.g., a notch or groove) thereon to facilitate attachment to head 150.

The present disclosure also contemplates the inclusion of tines and blades 162 of various sizes and/or materials that are removably securable to a portion of the ground-working tool 100. Depending of a variety of factors (e.g., hardness of soil, area to be cultivated, etc.), a user may want to utilize tines/blades 162 of different sizes (e.g., lengths, circumferences, lengths, widths, thicknesses) and/or strengths. It is also envisioned that the ground-working tool 100 can be used with a plurality of tines 162 removably secured to one arm 140/head 150 and at least one blade 162 (e.g., an elongated blade) removably secured to the other arm 140/head 150. Combinations of these various embodiments are also envisioned and are included in the present disclosure.

FIG. 14A illustrates a package 500 of four replacement blades 162c for use with ground-working tool 100 of FIG. 14. FIG. 15A illustrates a package 502 of four replacement blades 162d for use with ground-working tool 100 of FIG. 15. It is envisioned that each package 500, 502 may include any number of blades 162c and/or 162d, including a combination of blades 162c and 162d.

While the above description contains many specifics, these specifics should not be constructed as limitations on the scope of the present disclosure, but merely as illustrations of various embodiments thereof. Therefore, the above description should not be construed as limiting, but merely as exemplifications of various embodiments. Those skilled in the art will envision other modifications within the scope and spirit of the claims appended hereto.

What is claimed:

1. A ground-working tool, comprising:
a shaft;
a drive motor disposed in mechanical cooperation with the shaft;
a gear set configured to be driven by the drive motor;
at least one arm disposed in mechanical cooperation with the gear set and defining a longitudinal axis, wherein the at least one arm is movable proximally and distally in a reciprocating motion;
at least one head disposed in mechanical cooperation with the at least one arm; and
at least one blade being selectively removable from the at least one head.

2. The tool according to claim 1, wherein at least one of the head and the blade include attachment structure thereon to facilitate attachment between the head and the blade.

3. The tool according to claim 1, wherein the at least one blade includes an elongated ground-contacting surface, the elongated ground-contacting surface disposed substantially parallel to the longitudinal axis.

4. An attachment for use with a ground-working tool, the ground-working tool including a drive motor, a gear set configured to be driven by the drive motor, at least one arm disposed in mechanical cooperation with the gear set and defining a longitudinal axis wherein the at least one arm is movable proximally and distally in a reciprocating motion, the at least one head disposed in mechanical cooperation with the at least one arm; the attachment including:
at least one blade being selectively removable from the at least one head.

5. The attachment of claim 4, wherein the at least one blade includes an attachment structure thereon to facilitate attachment between the blade and the head of the ground-working tool.

6. The attachment of claim 4, wherein the at least one blade includes an elongated ground-contacting surface, the elongated ground-contacting surface disposed substantially parallel to the longitudinal axis of the ground-working tool.

7. The attachment of claim 4, wherein the at least one blade is configured to be snapped on to the at least one head.

8. The attachment of claim 4, wherein the at least one blade is longitudinally slidable with respect to the at least one head.

9. A package including at least one blade for use with a ground-working tool, the ground-working tool including a drive motor, a gear set configured to be driven by the drive motor, at least one arm disposed in mechanical cooperation with the gear set and defining a longitudinal axis wherein the at least one arm is movable proximally and distally in a reciprocating motion, the at least one head disposed in mechanical cooperation with the at least one arm; the package including:
at least one blade being selectively removable from the at least one head.

10. The package of claim 9, wherein the at least one blade includes an attachment structure thereon to facilitate attachment between the blade and the head of the ground-working tool.

11. The package of claim 9, wherein the at least one blade includes an elongated ground-contacting surface, the elongated ground-contacting surface disposed substantially parallel to the longitudinal axis of the ground-working tool.

12. The package of claim 9, wherein the at least one blade is configured to be snapped on to the at least one head.

13. The package of claim 9, wherein the at least one blade is longitudinally slidable with respect to the at least one head.
